(19) United States
(12) Patent Application Publication
(10) Pub. No.: US 2022/0291905 A1
(43) Pub. Date: Sep. 15, 2022

(54) APPARATUS AND METHOD FOR CREATING CONTENT PAGE BASED ON INTERMEDIATE LANGUAGE

(71) Applicant: IMFORM CO., LTD., Seoul (KR)

(72) Inventors: Hee Seon KIM, Seoul (KR); Jun Gi SHIN, Seoul (KR); Hye Jin AHN, Seongnam-si (KR)

(73) Assignee: IMFORM CO., LTD., Seoul (KR)

(21) Appl. No.: 17/707,599

(22) Filed: Mar. 29, 2022

Related U.S. Application Data
(63) Continuation of application No. PCT/KR2021/003039, filed on Mar. 11, 2021.

(30) Foreign Application Priority Data
Mar. 10, 2021 (KR) 10-2021-0031155

(51) Int. Cl. G06F 8/38; G06F 8/30; G06F 8/10

(52) U.S. Cl. CPC G06F 8/38; G06F 8/31; G06F 8/10

(57) ABSTRACT

The present disclosure relates to an apparatus and a method for creating a content page based on an intermediate language. The method includes the operations of: displaying a template for creating a page on a user interface (UI) screen; displaying a plurality of functional modules, classified by functions executable in the page, on the screen; inserting a function provided by at least one functional module set by a user, among the plurality of functional modules, and creating the page; creating a source file on the page on the basis of the predetermined intermediate language; and converting the source file into a programming language-based execution file of a type satisfying a service environment of the page.

### CROSS-REFERENCE TO RELATED APPLICATION

The present application is a continuation of International Patent Application No. PCT/KR2021/003039, filed on Mar. 11, 2021, which is based upon and claims the benefit of priority to Korean Patent Application No. 10-2021-0031155 filed on Mar. 10, 2021. The disclosures of the above-listed applications are hereby incorporated by reference herein in their entirety.

### BACKGROUND

### 1. Technical Field

The present disclosure relates to an apparatus and a method for creating a content page based on an intermediate language.

### 2. Description of Related Art

Due to the development of the information communications and the commercialization of smart terminals, many people can use a program or an application in real time regardless of time and place. Recently, people can carry out various tasks in daily life through applications installed in a smartphone. For example, a person can remotely control a smart lighting device through a smartphone, or can receive real-time image information about a residential area in a smartphone in a separated space.

As described above, smartphones have great influence on daily life, are increasing in number while the influence thereof is increasing. Therefore, a number of companies, organizations, and the like are leading the development of programs or applications to provide various services through smartphones. Recently, not only enterprises but also individual businesses or the public have developed applications for their specific purposes.

However, in the case of applications or programs, smart terminals use different programming languages according to operating system (OS) types using the corresponding applications or programs. As such, programming languages of the applications can be different, depending on the programming language used in a platform on which the application will be used. So, even in the case of applications for the same service, a plurality of applications must be formed according to an operating system of the smart terminal. Therefore, only limited applications based on a specific programming language are developed, or the general public, rather than experts, have a large burden of learning a plurality of programming languages.

Accordingly, it is necessary to provide a development environment in which users can easily develop programs and in which a programming language according to program service environments, namely, operating systems, can be developed.

### SUMMARY

The present disclosure has been made to solve the above-mentioned problems occurring in the prior art, and an aspect of the present disclosure is directed to providing an apparatus and a method for creating a content page based on an intermediate language.

The aspects of the present disclosure are not limited to those mentioned above, and other aspects not mentioned herein will be clearly understood by those skilled in the art from the following description.

To accomplish the above objects, in an aspect of the present disclosure, there is provided a method for creating a content page based on an intermediate language including the operations of: displaying a template for creating a page on a user interface (UI) screen for creating a page for content configuration; displaying a plurality of functional modules, classified by functions executable in the page, on the screen; inserting a function provided by at least one functional module set by a user, among the plurality of functional modules, and creating the page; creating a source file on the page on the basis of the predetermined intermediate language; and converting the source file into a programming language-based execution file of a type satisfying a service environment of the page, wherein the source file includes information on a function inserted into the page, the function information includes information on a size, a location and a design of an area, and arrangement method and sequence with other functions, required to perform the function in the page, the source file creating operation individually includes source information in a unit of at least one functional module inserted into the page, and the converting operation individually converts the source information in a unit of the at least one functional module.

In this instance, the method for creating a content page based on an intermediate language further includes the operation of: mapping and storing one or more functional modules and one or more intermediate language-based source codes for performing the function of the at least one functional module, wherein in the creating operation, a source code mapped with the at least one functional module set by the user among the stored source codes is extracted and created.

Moreover, the converting operation includes the operations of: identifying a programming language used in the service environment on the basis of service environment information when the user sets information on service environment of the page; and converting the intermediate language-based source code into an execution file based on the identified programming language.

Furthermore, the converting operation includes the operation of converting one intermediate language-based source code into a plurality of execution files based on a programming language corresponding to a plurality of service environments when the user sets information on the plurality of service environments.

In addition, the functional module includes a first functional module providing an image insertion function, and the converting step comprises the operation of automatically adjusting and converting the size of an image to be satisfied with the service environment of the page when at least one image is inserted into the page through the first module.

Moreover, the template is previously set in size according to a device to which a page will be provided, and the template displaying operation includes the operations of: receiving information of the device; and searching and displaying a template having a standard providable from the device on the basis of the received information of the device.

Additionally, the module is created in connection with a specific function which is commonly executable in the plurality of service environments.

In an aspect of the present disclosure, there is provided an apparatus for creating a content page based on an intermediate language including: a communication unit: a memory for mapping a template for creating a content page and an intermediate language-based source code for performing a function of a functional module with each functional module and storing the mapped template and the source code; and a control unit, which displays a template for creating a page on a user interface (UI) screen for creating a page for content configuration, displays a plurality of functional modules, classified by functions executable in the page, on the screen, inserts a function provided by at least one functional module set by a user, among the plurality of functional modules, and creating the page, creates a source file on the page on the basis of the predetermined intermediate language, and converts the source file into a programming language-based execution file of a type satisfying a service environment of the page, wherein the source file includes information on a function inserted into the page, and the function information includes information on a size, a location and a design of an area, and arrangement method and sequence with other functions, required to perform the function in the page, and wherein the control unit creates the source file by individually including source information in a unit of at least one functional module inserted into the page, and individually converts the source information into an execution file in a unit of at least one functional module.

In another aspect of the present disclosure, there is provided a computer program performing the intermediate language-based content page creating method. The computer program can be stored in a storage medium.

Besides the above, other methods and systems for embodying the present disclosure and a computer readable recording medium to record computer programs for executing the method may be additionally provided.

### BRIEF DESCRIPTION OF THE DRAWINGS

FIG. 1 is a schematic diagram of an intermediate language-based content page creating apparatus according to the present disclosure.

FIG. 2 is a flow chart schematically illustrating an intermediate language-based content page creating method according to the present disclosure.

FIG. 3 is an exemplary view illustrating a user interface screen for creating a page for content configuration according to the present disclosure.

FIG. 4 is an exemplary view illustrating that a plurality of functional modules are classified and displayed by function types according to the present disclosure.

FIG. 5 is an exemplary view illustrating that source files are created by functional module units used for creating a page according to the present disclosure.

FIG. 6 is a flow chart illustrating an operation of mapping and storing a functional module and an intermediate language-based source code corresponding to the functional module according to the present disclosure.

FIG. 7 illustrates an exemplary view illustrating an operation of extracting a source code mapped with the functional module and creating a source file of the page according to the present disclosure.

FIG. 8 is an exemplary view illustrating an operation of simultaneously converting one intermediate language-based source code into a plurality of execution files based on each programming language corresponding to the plurality of service environments according to the present disclosure.

### DETAILED DESCRIPTION

Advantages and features of the present disclosure and methods accomplishing the advantages and features will become apparent from the following detailed description of exemplary embodiments with reference to the accompanying drawings. However, the present disclosure is not limited to exemplary embodiment disclosed herein but will be implemented in various forms. The exemplary embodiments are provided so that the present disclosure is completely disclosed, and a person of ordinary skilled in the art can fully understand the scope of the present disclosure. Therefore, the present disclosure will be defined only by the scope of the appended claims.

Terms used in the specification are used to describe specific embodiments of the present disclosure and are not intended to limit the scope of the present disclosure. In the specification, the terms of a singular form may include plural forms unless otherwise specified. It should be also understood that the terms of ‘include’ or ‘have’ in the specification are used to mean that there is no intent to exclude existence or addition of other components besides components described in the specification. In the detailed description, the same reference numbers of the drawings refer to the same or equivalent parts of the present disclosure, and the term “and/or” is understood to include a combination of one or more of components described above. It will be understood that terms, such as “first” or “second” may be used in the specification to describe various components but are not restricted to the above terms. The terms may be used to discriminate one component from another component. Therefore, of course, the first component may be named as the second component within the scope of the present disclosure.

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein.

Hereinafter, preferred embodiments of the present disclosure will be described in detail with reference to the accompanying drawings.

The meaning of the terms used in the present disclosure will be briefly described with reference to the description. It should be noted, however, that the description of the terms is intended to assist in the understanding of the present disclosure, and is not intended to limit the technical spirit of the present disclosure if not explicitly disclosed in limiting the present disclosure.

The term, “unit”, used in the present disclosure means a hardware element, such as software, FPGA, or ASIC, and the “unit” performs some roles. However, the term, “unit”, is not limited to software or hardware. The “unit” may be configured in an addressable storage medium or may be configured to play one or more processors. Therefore, as an example, a “unit” includes elements, such as software elements, object-oriented software elements, class elements, and task elements, processes, functions, attributes, procedures, subroutines, segments of program codes, drivers, firmware, microcode, circuits, data, databases, data structures, tables, arrays, and variables. Functions provided within the elements and “units” may be combined with a smaller number of elements and “units” or may be further divided into additional elements and “units”.

In addition, all “units” in the present disclosure may be controlled by at least one processor, and the at least one processor may perform the operation performed by the “unit” of the present disclosure.

Embodiments of the present disclosure may be described in terms of a function or a block performing the function. A block which may be referred to as a “unit” or a “module” of the present disclosure can be physically implemented by an analog or digital circuit, such as a logic gate, an integrated circuit, a microprocessor, a microcontroller, a memory, a passive electronic component, an active electronic component, an optical component, or hardwired circuits, etc., and may be selectively operated by firmware and software.

Embodiments according to the present disclosure can be implemented using at least one software program executed on at least one hardware device, and can perform a network management function to control elements.

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein.

Hereinafter, preferred embodiments of the present disclosure will be described in detail with reference to the accompanying drawings.

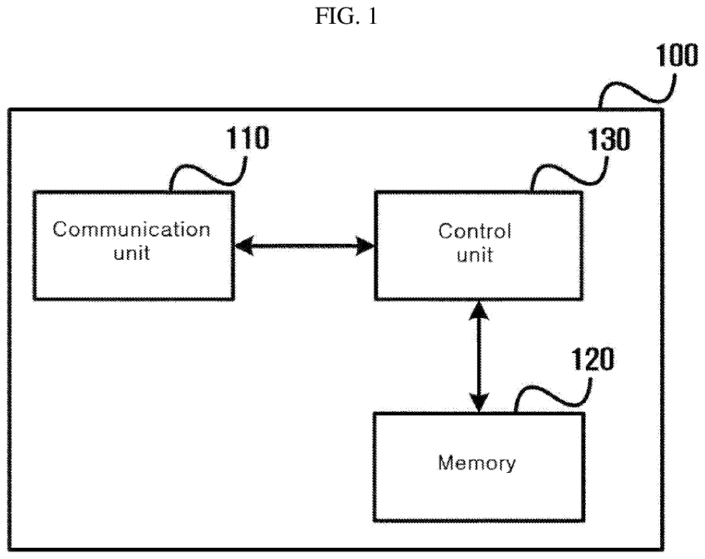

FIG. 1 is a schematic diagram of an intermediate language-based content page creating apparatus according to the present disclosure.

Referring to FIG. 1, the intermediate language-based content page creating apparatus 10 includes a communication unit 110, a memory 120, and a control unit 130.

Meanwhile, the intermediate language-based content page creating apparatus 10 may correspond to a platform server operated by a company providing an intermediate language-based content page creating service. However, the present invention is not limited thereto. The present disclosure will be described on the assumption that the intermediate language-based content page creating apparatus 10 is a server computer.

The communication unit 110 may receive information on service environment from a user terminal (not shown) or receive information on a functional module set through the user terminal (not shown). That is, the communication unit 110 may include one or more modules enabling wireless communication between the apparatus 10 and the user terminal (not shown). The communication unit 110 may include one or more modules which connect the apparatus 10 to one or more networks. Meanwhile, the communication unit 110 can transmit and receive various kinds of information between the apparatus 10 and the user terminal (not shown). The apparatus 10 can use various types of communication networks through the communication unit 110, and can use a wireless communication method, such as wireless local area network (WLAN), Wi-Fi, Wibro, Wimax, and high speed downlink packet access (HSDPA), or a wired communication method, such as Ethernet, xDSL (ADSL, VDSL), hybrid fiber coax (HFC), fiber to the curb (FTTC), fiber to the home (FTTH), and the like.

The memory 120 can store data supporting various functions of the apparatus 10. The memory 120 can store lots of application programs or applications operated in the apparatus 10, data and commands for operating the apparatus 10. Moreover, the memory 120 stores intermediate language-based content page creating programs and commands At least some of the application programs can exist for the basic functions of the apparatus 10. Meanwhile, application programs can be stored in the memory 120, and is installed on the apparatus 10 to execute operations or functions of the apparatus 10.

In addition to the operation related to the application program, the control unit 130 can control the overall operation of the apparatus 10. The control unit 130 can provide or process appropriate information or functions to a manager terminal by processing input or output signals, data, information, etc. through the components described above or by operating the application program stored in the memory 120.

Moreover, in order to operate the application program stored in the memory 120, the control unit 130 can control at least some of the components illustrated in FIG. 1. Furthermore, in order to operate the application program, the control unit 130 can operate at least two of the components included in the apparatus 10.

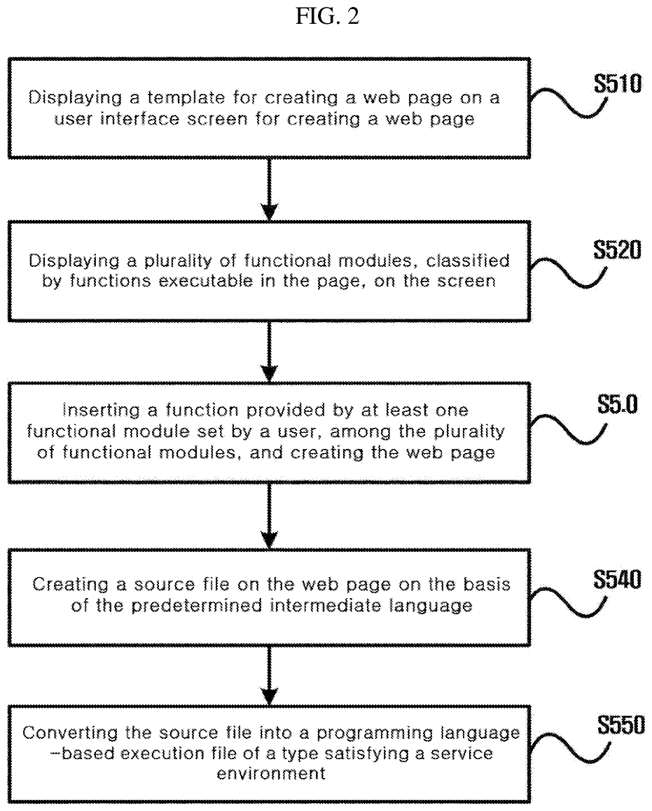

FIG. 2 is a flow chart schematically illustrating an intermediate language-based content page creating method according to the present disclosure.

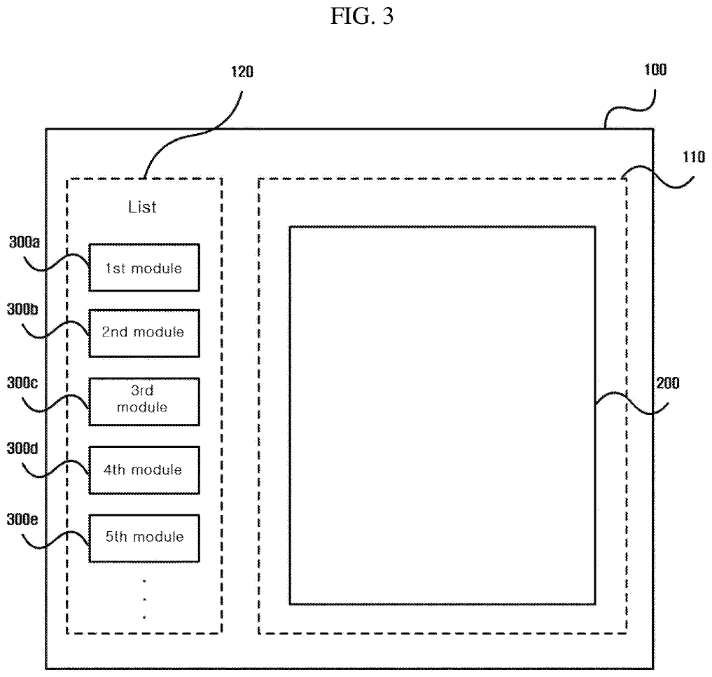

FIG. 3 is an exemplary view illustrating a user interface screen for creating a page for content configuration according to the present disclosure.

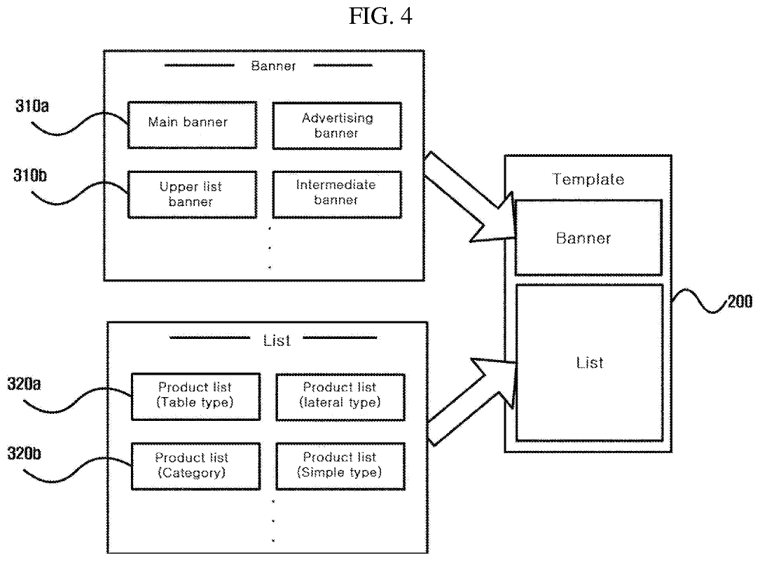

FIG. 4 is an exemplary view illustrating that a plurality of functional modules are classified and displayed by function types according to the present disclosure.

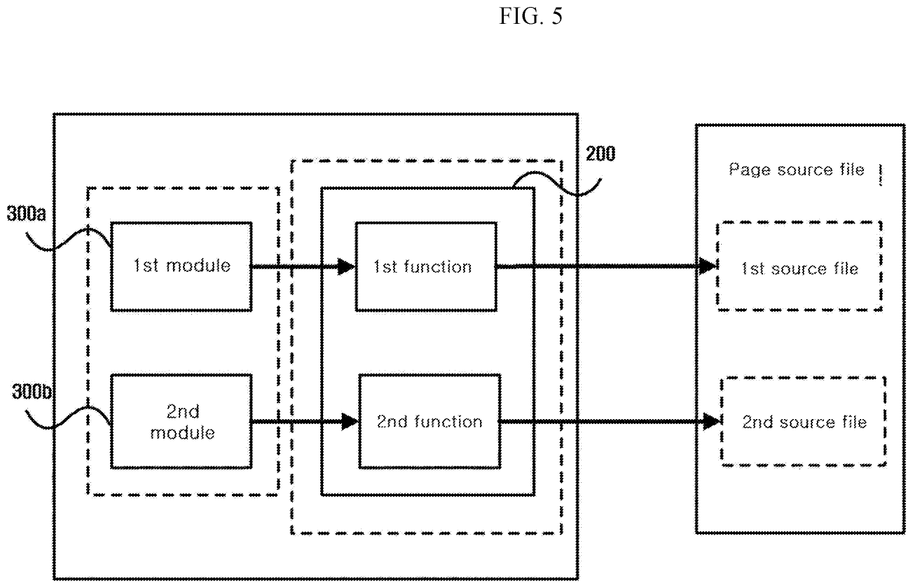

Operations illustrated in FIGS. 2 and 5 can be performed by the platform server. However, the operations are not limited thereto.

Referring to FIG. 2, first, the platform server (hereinafter, “server”) displays a template for creating a page on a user interface screen to create a page for contents configuration (S510).

In the present disclosure, contents mean information provided through a specific web page, a mobile page, and a reaction type page, for instance, a plurality of images and videos inserted in the web page based on a specific theme. The contents are not limited thereto, and include not only product information on specific products but also information provided on a web page or a mobile page according to various themes and purposes.

In the present disclosure, the page means a web page or a mobile page containing the contents. In more detail, the page includes a web page or a mobile page for services provided through a specific program or application. For instance, a mobile page required for service support, such as shopping, remittance, administration, reservation, and the like, in a super-application, such as Kakaotalk™, Naver™, and WeChat™, may correspond to the mobile page. In order to facilitate understanding of the present invention, for example, a page providing product information of pages for contents configuration will be described.

Meanwhile, when a user accesses a website of the server or executes a program provided by the server, the server displays a user interface screen for creating a web page on a screen of a user device.

Referring to FIG. 3, the user interface screen 100 is divided into a first area 110 for displaying a template for creating a content page and a second area 120 on which a functional module 300 is displayed. The first area 110 and the second area 120 is previously set in their positions and sizes and can be classified not to overlap each other, but may be relatively divided according to the contents displayed in the first area 110 and the second area 120.

Referring to FIG. 2, the control unit 130 of the server displays the plurality of functional modules 300, classified by functions executable in the page, on the screen (S520).

The functional module 300 may be classified and previously set by functions executable in the page. For instance, in the case of a page providing product information, each functional module 300 is set according to functions executable in the product information page, such as a product list, a destination list, a shopping basket list, and a bulletin board.

In addition, referring to FIG. 4, each functional module 300 can be classified according to function types and can be provided to a user. For example, in the case of the product information providing page, the functional module 300 can be classified and displayed according to a banner and a list. That is, a plurality of functional modules 300 related to an advertisement, a banner attached in a page, information on a product list related to the corresponding advertisement, and a plurality of functional modules 300 related to providing content are classified and displayed. The functional modules 300 are classified and displayed into a plurality of functional modules 300 related to advertisement and a banner attached to a page and a plurality of functional modules 300 providing information and contents to the product list related to the corresponding advertisement.

Meanwhile, referring to FIG. 4, even in the case of the same function, other functional modules 300 may be formed according to themes, arrangement forms, or the like, in the page. For example, in order to perform a function of providing product list information in the page, a functional module 320a for providing the corresponding product list information in a table type and a functional module 320b for providing the corresponding product list information in a category type can be set individually. Moreover, although not explicitly illustrated in the drawings, different functional modules may be set thematically depending on products which is the products that a user saw recently or which is the products that the user clicked the “Like” button in connection with the product list.

Meanwhile, referring to FIG. 3, the plurality of functional modules 300 are displayed on the second area 120 on the user interface screen, as described above. The user can search a specific functional module 300 providing a function to be inserted into the page among the plurality of functional modules 300 displayed in the second area 120.

Referring back to FIG. 2, the control unit 130 of the server inserts a function provided by at least one functional module set by the user, among the plurality of functional modules 300, into the template to create the page (S530).

In detail, when a user selects the specific functional module 300 displayed in the second area through the interface of the user device, the control unit 130 of the server inserts a specific function corresponding to the functional module 300 into a template displayed in the first area.

For example, assuming that the user has selected the specific functional module 300 related to a product list function, the product list function is inserted into the template displayed in the first area. In this instance, a layout that allows the user to insert contents, such as images or videos, related to products can be inserted into the template. That is, in order to insert an image into an HTML document, a user has to specify a path of the image on the basis of an <img> tag. However, the user can conveniently insert necessary functions in the page using the functional module 300, and especially, can observe a page creating process intuitively. by using the functional module 300 of the present invention,

Referring back to FIG. 2, the control unit 130 of the server creates a source file of the page based on a predetermined intermediate language (S540).

In detail, in the operation (S530), when creation of the page for contents configuration is completed, a source file of the corresponding page is created. In this instance, it is described that the operation (S530) and the operation (S54) are performed sequentially, but, according to the present disclosure, setting of the functional module 300 and creation of the source file of the corresponding functional module 300 can be performed at the same time.

Meanwhile, the page for the completed contents configuration is created on the basis of a preset intermediate language. The intermediate language is language independent of the platform and is language used in a process of converting programming language into machine language executable on a CPU. In detail, the intermediate language does not depend on the characteristics of a platform, such as a type of the CPU (e.g., x86, X64, ARM, etc.) of the platform or a type of the operating system (e.g., Windows®, Linux, OSX, iOS, Android, Windows mobile, window phones, etc.). A code written in the intermediate language can be converted into a binary code corresponding to a specific platform when the code is later compiled. On the other hand, according to the present disclosure, the intermediate language may be JavaScript Object Notation (JSON).

Meanwhile, the source file refers to a file created on the basis of the source code related to the completed content page. According to the present disclosure, the source file includes source information for at least one function inserted into the page in a module unit. In this instance, the source information may include information about a size, a location, a design, and arrangement method and sequence with other functions required to perform the function in the page. For example, through the functional module 300 related to the product list, the source file of the page into which the product list function is inserted may be a source code including path information of images related to products, and information on sizes and locations of the images, and designs in the page related to the product list.

Meanwhile, the source information may further include information on an interworking method or a communication method with other functions corresponding to another functional module inserted into the page. That is, the source information may further include information on a method and a sequence of interworking with other functions or a method of communicating with other functions in performing functions inserted in the page by the functional modules. For instance, assume that a product list and a shopping basket function are added in the page through a functional module of the “product list” and a functional module of the “shopping basket.” In this instance, when a user selects a specific product from the product list, the source information on the “product list” function may further include information for storing the corresponding product in the “shopping basket” list of the user in link with the “shopping basket” function. That is, the source file corresponding to each functional module may further include information on an interworking method or a communication method with a function by at least one functional module included in the page.

In this instance, each functional module 300 matches a source file related to a function provided by the corresponding functional module 300. A source file corresponding to the functional module 300 is stored in the memory according to each functional module 300. That is, the source file includes function information executable in the page through the corresponding source file. In this instance, the function information includes information on the location and size of the area within the page necessary to perform the corresponding function. In this instance, the location of the area and the size of the area may mean a location and a size of the layout provided to the user to insert the corresponding function. In the meantime, the function information further includes design information of a content to perform the corresponding function. Furthermore, the function information may include information on the arrangement method and sequency with other functions inserted by different functional modules 300.

Meanwhile, according to the present disclosure, in the source file creating operation, source information may be individually included in a unit of the at least one functional module 300 inserted in the page.

In detail, a source code for each functional module 300 can be included in the entire source code related to the source file of the page in a unit of each functional module 300 by forming a block. In this instance, the block means that the source code corresponding to each functional module 300 is included in an individually divided specific area. On the other hand, each source code for each functional module 300 in the entire source code can be arranged on the basis of the arrangement sequence and location with other modules in the source information described above.

FIG. 5 is an exemplary view illustrating that a source file is created in the unit of the functional module used to create a page according to the present disclosure.

Referring to FIG. 5, the functional module 300 selected by the user to create a page is a first functional module and a second functional module. As described above, a first function corresponding to the first functional module and a second function corresponding to the second functional module are inserted into the corresponding page. When a page including the first function and the second function is completed, a source file includes source files, which correspond to the functional modules 300 and are separated individually, in a unit of the functional module 300 inserted into the page. In other words, referring to FIG. 5, it is confirmed that the first code corresponding to the first functional module and the second code corresponding to the second functional module respectively form blocks and are arranged in the entire source codes of the page. In other words, when the server creates the source file, a source file on the entire page is created by identifying the functional modules 300 used in the completed page and inserting source codes corresponding to the functional modules 300 in a unit of the functional modules 300.

Referring back to FIG. 2, the control unit 130 of the server converts the source file into an execution file based on a programming language of a format satisfying the service environment of the page (S550).

In detail, the control unit 130 of the server converts a source file based on JSON language into an execution file made in programming language of the service environment in which the corresponding page will be used, for instance, the format satisfying a specific platform. In this instance, the server can individually convert source information in the unit of the at least one functional module. That is, like the source file creation, conversion of the execution file based on the programming language is based on the functional module.

In detail, source codes individually forming blocks according to the functional modules in the source file are respectively converted into programming language satisfied in the service environment so as to finally create an execution file. For instance, in order to compile the entire source code based on JSON language of the completed page, source codes corresponding to the functional modules in the entire source codes are identified, and each of the source codes is compiled into programming language. The source codes are converted into the programming language in the units of the functional modules. In addition, the converted programming language is combined to finally create an execution file in the corresponding platform.

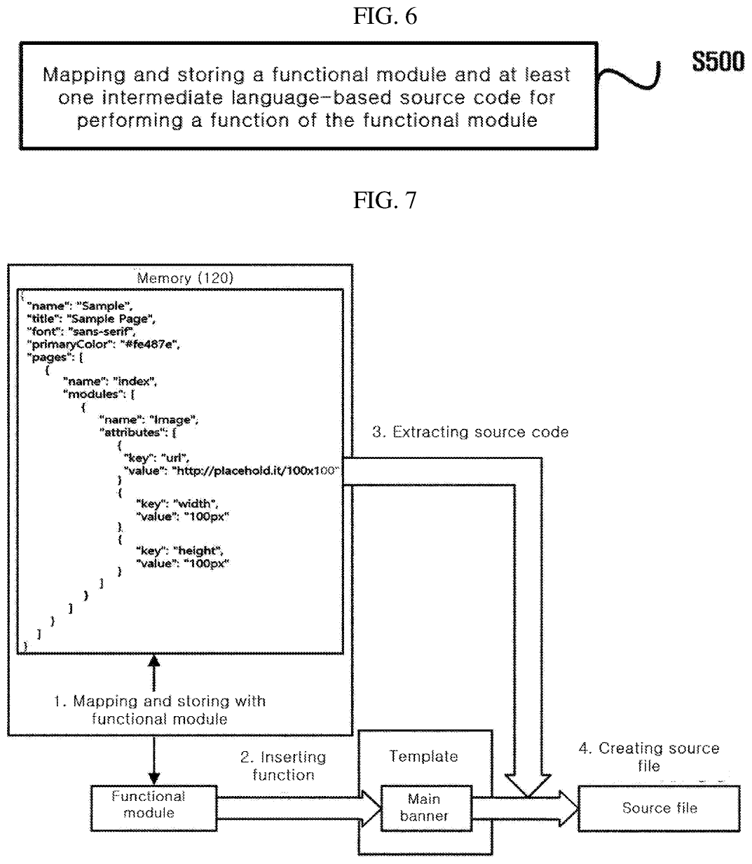

FIG. 6 is a flow chart illustrating an operation of mapping and storing a functional module and an intermediate language-based source code corresponding to the functional module according to the present disclosure.

FIG. 7 is an exemplary view illustrating an operation of extracting a source code mapped with the function module and creating a source file of the page.

Referring to FIG. 6, according to the present disclosure, the method may further include the operation of: mapping and storing at least one functional module and at least one source code based on the intermediate language for performing the function of the at least one functional module (S500). In this instance, the creating operation (S540) can extract and create a source code mapped with at least one functional module set by the user among the stored at least one source code.

In detail, the control unit 130 of the server 10 maps a JSON source code for each functional module to each functional module and stores the mapped source code in a memory. Moreover, the functional module set to create a page by a user is identified. After that, the JSON source code for the identified functional module is extracted.

Referring to FIG. 7, a source code for the functional module 300 related to a main banner is stored in the memory 120 of the server 10. In this instance, the source code is stored after being mapped with the functional module with respect to the main banner. Meanwhile, the control unit 130 sets the functional module 300 related to the main banner by the user, and extracts the source code mapped to the functional module stored in the memory 120 when a function related to the main banner is inserted into the template. After that, a source file of the page is created based on the extracted source code.

According to the present disclosure, in the converting operation, if information on the service environment of the page is set by the user, based on the service environment information, programming language used in the service environment is identified, and the intermediate language-based source code can be converted into an execution file based on the identified programming language.

In detail, when the intermediate language-based source file is created, the server 10 receives information on the service environment from the user. Furthermore, the server 10 identifies the programming language used in the corresponding service environment on the basis of the input service environment information. For example, it is assumed that a page related to a mini program used on a WeChat platform is created. In this instance, the user can easily create a page for content configuration by using the functional module provided from the server. The server creates a source file of the JSON language for the completed page. In this instance, when information on the service environment information of the corresponding page and the information on the WeChat platform are set by the user, the server identifies programming language corresponding to the WeChat platform. The source file based on the JSON language is converted into the identified programming language, and finally the execution file is finally generated.

To this end, the memory 120 of the server 10 can store the programming language used in each platform or the service environment in advance.

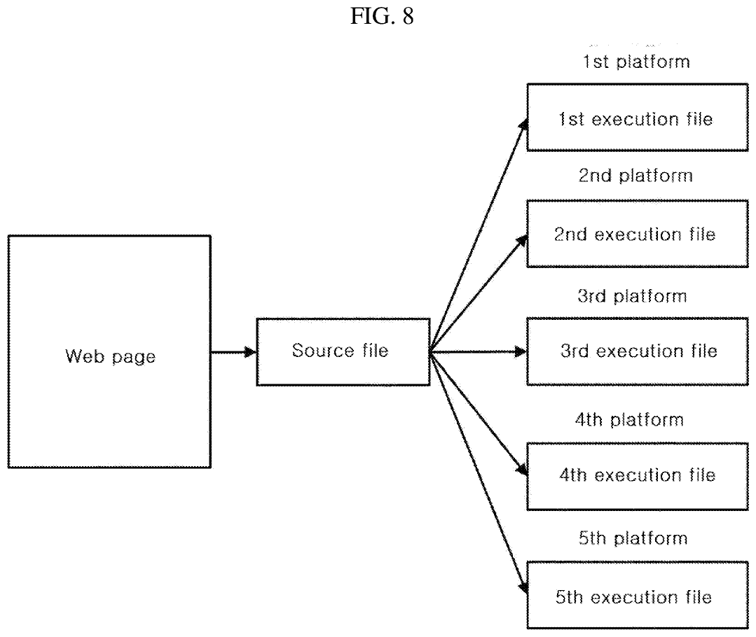

FIG. 8 is an exemplary view illustrating an operation of simultaneously converting one intermediate language-based source code into a plurality of execution files based on each programming language corresponding to the plurality of service environments according to the present disclosure.

Meanwhile, according to the present disclosure, in the converting operation, if the user sets information on a plurality of service environments, one intermediate language-based source code can be simultaneously converted into a plurality of programming language-based execution files corresponding to the plurality of use environments.

Referring to FIG. 8, the server creates one source file for the page created using the functional module 300. In this instance, if the user sets a plurality of service environment information, the server simultaneously converts the plurality of service environment information into programming language-based execution files respectively corresponding to the service environments.

Accordingly, it is not necessary for a user to individually learn programming languages used in platforms or service environments. The user can easily create a page for contents configuration just by unit functional modules, and convert one intermediate language-based source file into programming language suitable for the service environment that the user will use the page.

In addition, although not explicitly depicted in the drawings, the functional module may include a first functional module providing an image insertion function. In this instance, when at least one image is inserted into the page through the first module, the server can automatically adjust and convert the size of the image to satisfy the service environment of the page.

In addition, according to the present disclosure, the template is previously set in size according to a device to which the page will be provided. In the operation of displaying the template, information on the device is received, and a template having a standard that the device can provide is searched and displayed on the basis of the received information on the device.

In detail, the server can receive information on the device providing the page for content configuration from the user. For example, the device may be a mobile terminal, a tablet, and a computer. In this instance, the mobile terminal, the tablet, and the computer are different in size and standard of displays, namely, output devices. Therefore, the server displays a template corresponding to the device according to the device information input from the user. Accordingly, the user can be provided with a template of a standard related to a specific device in advance. In addition, through the template, a page capable of providing content suitable for a device can be created.

Meanwhile, according to the present disclosure, the functional module can be created in connection with a specific function which can be commonly performed in the plural service environments.

Specifically, the server 10 sets a service environment in which the created page is available, for example, a platform in advance. Moreover, the functional module 300 can be created only for a common specific function which can be performed in the page used in the predetermined plural platforms. Accordingly, the user can create a plurality of execution files executable in a plurality of different platforms on the basis of one intermediate language-based source file.

According to the present disclosure, a user can create a webpage, a program, or an application for providing contents through functional modules without the need to learn programming skills.

Additionally, the present disclosure converts one intermediate language-based source file into executable files in lots of service environments, for example, in a plurality of platforms, at the same time so that there is no need to individually learn programming languages used in individual service environments or to individually create pages.

The method according to an embodiment of the present disclosure can be implemented as a program (or application) to be executed by being combined with a server which is hardware, and can be stored in a medium.

The program may include code coded as a computer language, such as C, C++, Java, machine language, etc. which a processor (CPU) of the computer can read through a device interface of a computer. The code may include a functional code associated with a function that defines necessary functions for executing the methods, and may include an execution procedure-related control code in which the processor of the computer needs to execute the functions according to predetermined procedures. In addition, the code may further include additional information necessary for the processor of the computer to execute the functions or memory reference-related code for whether the media should be referenced in which location (address) of the internal or external memory of the computer. Moreover, if communication with any other computer or server in a remote location is required to execute the functions by the process of the computer, the code may further include communication-related code for how to communicate with any other computer or server at a remote location using the communication module of the computer, or whether or not any information or media should be transmitted and received in the communication.

The medium to be stored refers not to a medium storing data for a short time but to a medium that stores data semi-permanently, like a register, cache, memory, and the like, and means a medium readable by a device. In detail, as examples of the medium to be stored, there are read-only memories (ROMs), random access memories (RAMs), CD-ROMs, magnetic tapes, floppy disks, optical data storage devices, and the likes, but the present disclosure is not limited thereto. That is, the program can be stored in various recording media on a variety of servers that can be accessed by a computer or various recording media on the user's computer. Furthermore, the media can store code that is distributed to a computer system connected to the network and that is readable by the computer in a distributed fashion.

The method or algorithm described in relation to the embodiments of the present disclosure can be directly embodied in hardware, can be embodied in a software module executed by hardware, or can be embodied by combination thereof. The software module can reside in a random access memory (RAM), a read-only memory (ROM), an erasable programmable read-only memory (EPROM), an electrically erasable programmable read-only memory (EEPROM), a flash memory, a hard disk, a detachable disk, a CD-ROM, or a medium readable by a computer, well-known in the technical field to which the present disclosure belongs.

The above description is only exemplary, and it will be understood by those skilled in the art that the disclosure may be embodied in other concrete forms without changing the technological scope and essential features. Therefore, the above-described embodiments should be considered only as examples in all aspects and not for purposes of limitation.

1. A method for creating a content page based on an intermediate language comprising the operations of:
displaying a template for creating a page on a user interface (UI) screen for creating a page for content configuration;
displaying a plurality of functional modules, classified by functions executable in the page, on the screen;
inserting a function provided by at least one functional module set by a user, among the plurality of functional modules, and creating the page;
creating a source file on the page on the basis of the predetermined intermediate language; and
converting the source file into a programming language-based execution file of a type satisfying a service environment of the page,
wherein the source file includes source information on at least one function inserted into the page in a unit of a module,
wherein the source information includes information on at least one of a size, a location and a design of an area, and arrangement method and sequence with other functions, required to perform the corresponding function in the page, and
wherein in the converting operation, the source information on the at least one function in the source file is converted into a unit of a module.

2. The method according to claim 1, further comprising the operation of:
mapping and storing one or more functional modules and one or more intermediate language-based source codes for performing the function of the at least one functional module,
wherein in the creating operation, a source code mapped with the at least one functional module set by the user among the stored source codes is extracted and created.

3. The method according to claim 1, wherein the converting operation comprises the operations of:
identifying a programming language used in the service environment on the basis of service environment information when the user sets information on service environment of the page; and
converting the intermediate language-based source code into an execution file based on the identified programming language.

4. The method according to claim 3, wherein the converting operation comprises the operation of converting one intermediate language-based source code into a plurality of execution files based on a programming language corresponding to a plurality of service environments when the user sets information on the plurality of service environments.

5. The method according to claim 4, wherein the module is created in connection with a specific function which is commonly executable in the plurality of service environments.

6. The method according to claim 3, wherein the functional module includes a first functional module providing an image insertion function, and
wherein the converting step comprises the operation of automatically adjusting and converting the size of an image to be satisfied with the service environment of the page when at least one image is inserted into the page through the first module.

7. The method according to claim 1, wherein the template is previously set in size according to a device to which a page will be provided, and
wherein the template displaying operation includes the operations of:
receiving information of the device; and
searching and displaying a template having a standard providable from the device on the basis of the received information of the device.

8. A computer program stored in a computer-readable recording medium to perform the intermediate language-based content page creating method of claim 1 in connection with a computer.

9. An apparatus for creating a content page based on an intermediate language comprising:
a communication unit;
a memory for mapping a template for creating a content page and an intermediate language-based source code for performing a function of a functional module with each functional module and storing the mapped template and the source code; and
a control unit, which displays a template for creating a page on a user interface (UI) screen for creating a page for content configuration, displays a plurality of functional modules, classified by functions executable in the page, on the screen, inserts a function provided by at least one functional module set by a user, among the plurality of functional modules, and creating the page, creates a source file on the page on the basis of the predetermined intermediate language, and converts the source file into a programming language-based execution file of a type satisfying a service environment of the page,
wherein the source file includes information on a function inserted into the page, and the function information includes information on a size, a location and a design of an area, and arrangement method and sequence with other functions, required to perform the function in the page, and
wherein the control unit creates the source file by individually including source information in a unit of at least one functional module inserted into the page, and individually converts the source information into an execution file in a unit of at least one functional module.

10. The apparatus according to claim 9, wherein the control unit maps and stores one or more functional modules and one or more intermediate language-based source codes for performing the function of the at least one functional module, and extracts and creates a source code mapped with the at least one functional module set by the user among the stored source codes.

11. The apparatus according to claim 9, wherein the control unit identifies programming language used in the service environment on the basis of service environment information when the user sets information on service environment of the page, and converts the intermediate language-based source code into an execution file based on the identified programming language.

12. The apparatus according to claim 11, wherein the control unit converts one intermediate language-based source code into a plurality of execution files based on a programming language corresponding to a plurality of service environments when the user sets information on the plurality of service environments.

13. The apparatus according to claim 11, wherein the module is created in connection with a specific function which is commonly executable in the plurality of service environments.

14. The apparatus according to claim 11, wherein the functional module includes a first functional module providing an image insertion function, and
wherein the control unit automatically adjusts and converts the size of an image to be satisfied with the service environment of the page when at least one image is inserted into the page through the first module.

15. The apparatus according to claim 9, wherein the template is previously set in size according to a device to which a page will be provided, and
wherein the control unit receives information of the device, and searches and displays a template having a standard providable from the device on the basis of the received information of the device.
